(19) United States
(12) Patent Application Publication
(10) Pub. No.: US 2025/0158134 A1
(43) Pub. Date: May 15, 2025

(54) ELECTRODE PLATE, ELECTRODE ASSEMBLY AND SECONDARY BATTERY

(71) Applicant: SAMSUNG SDI CO., LTD., Yongin-si (KR)

(72) Inventor: Yeon Gap KIM, Suwon-si (KR)

(21) Appl. No.: 18/659,882

(22) Filed: May 9, 2024

(30) Foreign Application Priority Data
Nov. 15, 2023 (KR) 10-2023-0158116

(51) Int. Cl. H01M 10/0587; H01M 4/13; H01M 10/04; H01M 50/103; H01M 50/105

(52) U.S. Cl. CPC H01M 10/0587; H01M 4/13; H01M 10/0431; H01M 50/103; H01M 50/105

(57) ABSTRACT

An electrode plate, an electrode assembly, and a secondary battery are disclosed. An electrode plate includes a base; and an active material layer on the base and including a plurality of regions each having a pattern thereon, the plurality of regions including a first region and a second region having a greater number of patterns than the first region.

### CROSS-REFERENCE TO RELATED APPLICATION

The present application claims priority to and the benefit of Korean Patent Application No. 10-2023-0158116, filed on Nov. 15, 2023 in the Korean Intellectual Property Office, the entire disclosure of which is incorporated herein by reference.

### BACKGROUND

### 1. Field

Aspects of embodiments of the present disclosure relate to an electrode plate, an electrode assembly, and a secondary battery.

### 2. Description of the Related Art

A secondary battery is a battery that can be charged and discharged, unlike a primary battery that cannot be charged. Low-capacity secondary batteries may be used in small portable electronic devices, such as smartphones, feature phones, notebook computers, digital cameras, and camcorders, while large-capacity secondary batteries are widely used as power sources for driving motors and power storage batteries in hybrid and electric vehicles and the like. Such a secondary battery includes electrodes including a cathode and/or an anode, an electrode assembly including the electrodes, a case receiving the electrode assembly therein, and electrode terminals connected to the electrode assembly.

With the recent development of science and technology, secondary batteries are applied to various devices. As a result, there is a need for high performance secondary batteries with low resistance and high output. As measures for reducing resistance of such a secondary battery, a number of tabs of the secondary battery may be increased. However, such a secondary battery with leading end tabs may have problems of an increase in internal stress and vulnerability to deformation.

This section is intended only to provide a better understanding of the background of the invention and thus may include information which is not necessarily prior art.

### SUMMARY

According to an aspect of embodiments of the present invention, an electrode plate having a pattern formed on at least a portion thereof, an electrode assembly including electrodes, and/or a secondary battery including an electrode assembly is provided.

According to another aspect of embodiments of the present invention, an electrode plate, an electrode assembly, and/or a secondary battery having improved deformation characteristics is provided.

According to another aspect of embodiments of the present invention, an electrode plate, an electrode assembly, and/or a secondary battery that has improved characteristics in electrolyte impregnation and/or ion mobility is provided.

According to another aspect of embodiments of the present invention, an electrode plate, an electrode assembly, and/or a secondary battery that has an increased reaction surface area is provided.

The above and other aspects and features of the present invention will become apparent from the following description of embodiments of the present invention.

According to one or more embodiments of the present invention, an electrode plate includes: a base; and an active material layer on the base and including a plurality of regions each having a pattern on a surface thereof, wherein the plurality of regions includes a first region and a second region having a greater number of patterns than the first region.

According to one or more embodiments of the present invention, an electrode assembly includes: a laminate including a cathode, an anode, and a separator between the cathode and the anode, wherein at least one of the cathode and the anode includes a base; and an active material layer on the base and including a plurality of regions each having a pattern on a surface thereof, and the plurality of regions includes a first region and a second region having a greater number of patterns than the first region.

According to one or more embodiments of the present invention, a secondary battery includes the electrode assembly described above; and a case receiving the electrode assembly therein.

One or more embodiments of the present invention provide an electrode plate, an electrode assembly, and/or a secondary battery that reduces precipitation of lithium (Li) ions.

Further, one or more embodiments of the present invention provide an electrode plate, an electrode assembly, and/or a secondary battery that has improved high power and/or low temperature life span characteristics.

Further, one or more embodiments of the present invention provide an electrode plate, an electrode assembly, and/or a secondary battery that suppresses increase in swelling force.

Further, one or more embodiments of the present invention provide an electrode plate, an electrode assembly, and/or a secondary battery that secures long life span.

In accordance with one or more embodiments of the present invention, a battery pack including a secondary battery with an improved structure and/or an automobile including such a battery pack is provided.

However, aspects and features of the present invention are not limited to those described above and other aspects and features not mentioned will be clearly understood by those skilled in the art from the detailed description given below.

### BRIEF DESCRIPTION OF THE DRAWINGS

The following drawings attached to this specification illustrate some embodiments of the present invention, and further describe aspects and features of the present invention together with the detailed description of the present invention. However, the present invention should not be construed as being limited to the drawings.

FIG. 1 is an exploded perspective view of a pouch type battery according to an embodiment of the present invention;

FIG. 2 is a perspective view of a prismatic battery according to an embodiment of the present invention;

FIG. 3 is a cross-sectional view of the prismatic battery of FIG. 2, taken along the line II-II;

FIG. 4 is a schematic view of an electrode plate according to an embodiment of the present invention;

FIG. 5 is a schematic view of an electrode assembly according to an embodiment of the present invention;

FIG. 6A and FIG. 6B are schematic views of electrode plates according to embodiments of the present invention;

FIG. 7 is a schematic view of an electrode plate according to an embodiment of the present invention;

FIG. 8 is a schematic view of an electrode assembly according to an embodiment of the present invention;

FIG. 9 is a schematic view of an electrode plate according to an embodiment of the present invention

FIG. 10 is a schematic view of an electrode assembly according to an embodiment of the present invention;

FIG. 11 is a table showing performance of electrode plates according to embodiments of the present invention;

FIG. 12 is a perspective view of a battery pack according to an embodiment of the present invention; and

FIG. 13A and FIG. 13B are views of a vehicle body and body parts according to embodiments of the present invention.

### DETAILED DESCRIPTION

Herein, some example embodiments of the present invention will be described, in further detail, with reference to the accompanying drawings. The terms or words used in this specification and claims should not be construed as being limited to the usual or dictionary meaning and should be interpreted as having meanings and concepts consistent with the technical idea of the present invention based on the principle that the inventor can be his/her own lexicographer to appropriately define the concept of the term to explain his/her invention in the best way. The embodiments described in this specification and the configurations shown in the drawings are some example embodiments of the present invention and do not necessarily represent all of the technical ideas, aspects, and features of the present invention. Accordingly, it is to be understood that there may be various equivalents and modifications that can replace or modify the embodiments described herein at the time of filing this application.

It is to be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements.

References to two compared elements, features, etc. as being “the same,” may mean that they are the same or substantially the same. Thus, the phrase “the same” or “substantially the same” may include a case having a deviation that is considered low in the art, for example, a deviation of 5% or less. In addition, when a certain parameter is referred to as being uniform in a given region, it may mean that it is uniform in terms of an average.

It is to be understood that, although the terms “first,” “second,” “third,” etc. may be used herein to describe various elements, components, regions, layers, and/or sections, these elements, components, regions, layers, and/or sections are not to be limited by these terms. These terms are used to distinguish one element, component, region, layer, or section from another element, component, region, layer, or section. Thus, a first element, component, region, layer, or section discussed below could be termed a second element, component, region, layer, or section, unless specified otherwise.

Throughout the specification, unless specified otherwise, each element may be singular or plural.

When an arbitrary element is referred to as being disposed (or located or positioned) “above” (or “below”) or “on” (or “under”) a component, it may mean that the arbitrary element is placed in contact with the upper (or lower) surface of the component and may also mean that another component may be interposed between the component and any arbitrary element disposed (or located or positioned) on (or under) the component.

In addition, it is to be understood that, when an element is referred to as being “coupled,” “linked,” or “connected” to another element, the elements may be directly “coupled,” “linked,” or “connected” to each other, or one or more intervening elements may be present therebetween, through which the element may be “coupled,” “linked,” or “connected” to another element. In addition, when a part is referred to as being “electrically coupled” to another part, the part may be directly connected to another part or one or more intervening parts may be present therebetween such that the part and another part are indirectly connected to each other.

Throughout the specification, when “A and/or B” is stated, it means A, B, or A and B, unless stated otherwise. That is, “and/or” includes any or all combinations of a plurality of items enumerated. When “C to D” is stated, it means C or more and D or less, unless specified otherwise.

The terminology used herein is for the purpose of describing embodiments of the present invention and is not intended to be limiting of the present invention.

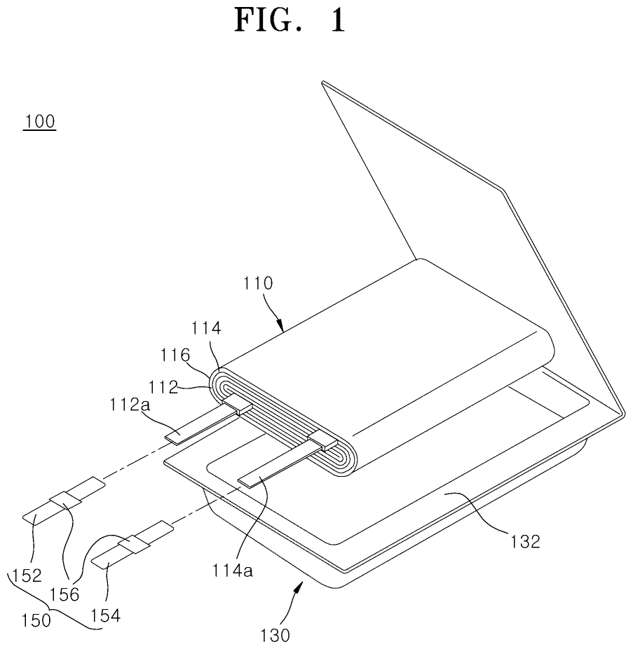

FIG. 1 is an exploded perspective view of a pouch type battery according to an embodiment of the present invention.

Referring to FIG. 1, a secondary battery 100 includes an electrode assembly 110 and a pouch 130 that receives the electrode assembly 110 therein.

The electrode assembly 110 includes an anode plate 112, which is a first electrode plate, a cathode plate 114, which is a second electrode plate, and a separator 116 interposed therebetween. The anode plate 112 is provided with an anode tab 112a electrically connected to an anode uncoated portion, and the cathode plate 114 is provided with a cathode tab 114a electrically connected to a cathode uncoated portion. The anode tab 112a and the cathode tab 114a are welded to an anode lead 152 and a cathode lead 154 of external terminals to be electrically connected to the external terminals, respectively. In an embodiment, tab films 156 are attached to the anode lead 152 and the cathode lead 154 to insulate the anode lead 152 and the cathode lead 154 from the pouch 130.

With the electrode assembly 110 received in the pouch 130, sealing portions 132 are brought into contact with each other along a periphery of the pouch 130 to seal the pouch 130. Here, the pouch 130 is sealed along the sealing portions 132, with the tab films 156 disposed between the sealing portions 132. As shown in FIG. 1, a form of the tab film 156 attached to each of the anode tab 112a and the cathode tab 114a is defined as a “detachable tab film” (such a sealing structure is defined as a detachable sealing structure).

In an embodiment, in the pouch 130, the sealing portions 132 are formed of a hot-melt material and are sealed by bonding hot-melt material layers to each other. Since the hot-melt material generally exhibits weak adhesion to metal, the thin film-shaped tab films 156 are attached to the tabs to fuse with the pouch 130. However, the detachable sealing structure may have a problem in that the tab film 156 is individually attached to each of the tabs for welding and then thermally fused with the pouch 130 again, causing deterioration in workability and productivity.

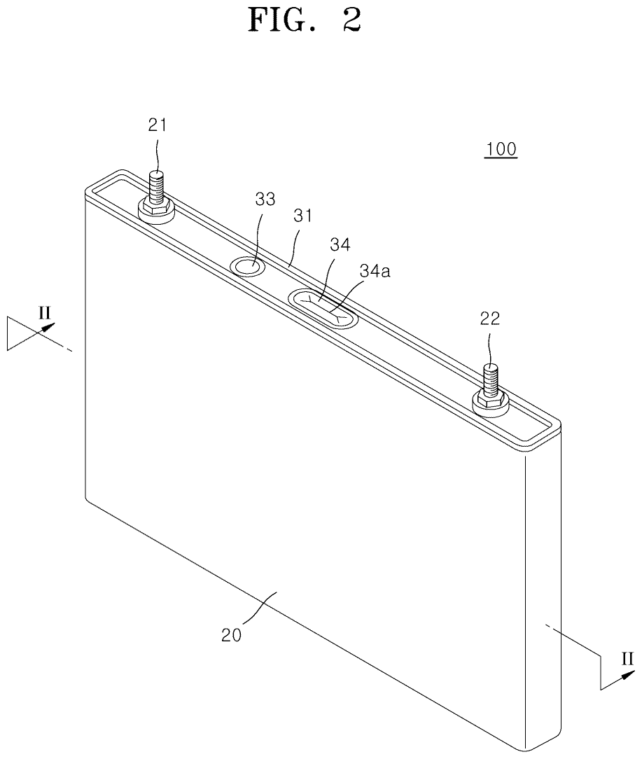

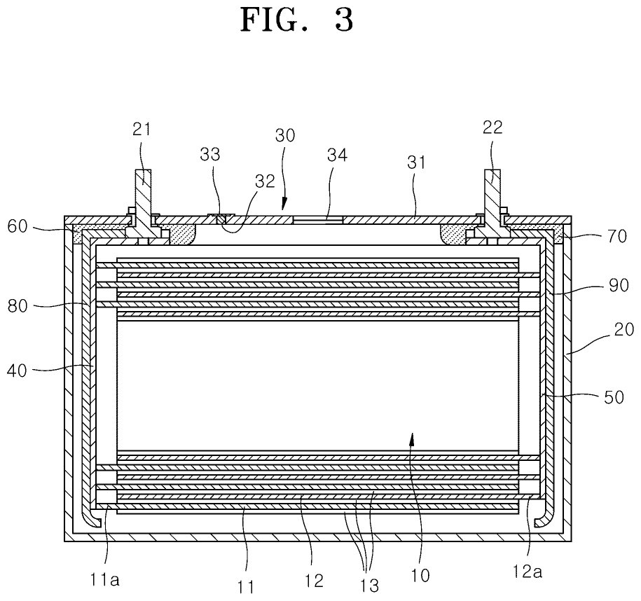

FIG. 2 is a perspective view of a prismatic battery according to an embodiment of the present invention; and FIG. 3 is a cross-sectional view of the prismatic battery of FIG. 2, taken along the line II-II of FIG. 2.

Referring now to FIG. 2 and FIG. 3, the secondary battery 100 according to the present embodiment may include at least one electrode assembly 10, which includes a cathode 11, an anode 12 and a separator 13 interposed therebetween, a case 20 receiving the electrode assembly 10 therein, and a cap assembly 30 coupled to an opening of the case 20.

The secondary battery 100 according to the present embodiment may be a lithium-ion secondary battery and will be described as a prismatic battery by way of example. However, it is to be understood that the present invention is not limited thereto and may be applied to various types of batteries, such as lithium polymer batteries, cylindrical batteries, and the like.

Each of the cathode 11 and the anode 12 may include a current collector formed of a thin sheet of metal foil, a coated portion corresponding to a region of the current collector coated with an active material, and an uncoated portion 11a; 12a corresponding to a region of the current collector without an active material coated.

The cathode 11 and the anode 12 are wound with the separator 13 interposed as an insulator therebetween. However, it is to be understood that the present invention is not limited thereto, and the electrode assembly 10 may have a structure in which multiple sheets of cathodes and anodes are alternately stacked, with the separator interposed therebetween.

The case 20 constitutes an overall appearance of the secondary battery 100 and may be formed of a conductive metal, such as aluminum, an aluminum alloy, or nickel-plated steel. In addition, the case 20 may provide a space in which the electrode assembly 10 is received.

The cap assembly 30 may include a cap plate 31 that covers the opening of the case 20, and the case 20 and the cap plate 31 may be formed of a conductive material. In an embodiment, cathode and anode terminals 21, 22 electrically connected to the cathode 11 and the anode 12 may be provided to the secondary battery 100 to protrude from the cap plate 31 therethrough.

In an embodiment, an upper post of each of the cathode and anode terminals 21, 22 protruding outward from the cap plate 31 may have a threaded outer peripheral surface to be secured to the cap plate 31 with a nut.

However, it is to be understood that the present invention is not limited thereto, and, for example, each of the cathode and anode terminals 21, 22 may have a rivet structure to allow rivet coupling or may be welded to the cap plate 31.

The cap plate 31 may be made of a thin plate and coupled to the opening of the case 20 and may be formed with an electrolyte inlet 32, to which a sealing stopper 33 may be provided, and a vent 34 formed with a notch 34a.

The cathode and anode terminals 21, 22 may be electrically connected to the current collectors, which include a first current collector 40 and a second current collector 50 (herein referred to as cathode and anode current collectors) welded to the cathode uncoated portion 11a and the anode uncoated portion 12a, respectively.

For example, the cathode and anode terminals 21, 22 may be welded to the cathode and anode current collectors 40, 50. However, it is to be understood that the present invention is not limited thereto and, in an embodiment, the cathode and anode terminals 21, 22 may be integrally formed with the cathode and anode current collectors 40, 50, respectively.

Further, an insulating member may be interposed between the electrode assembly 10 and the cap plate 31. Here, the insulating member may include first and second lower insulating members 60, 70 each disposed between the electrode assembly 10 and the cap plate 31.

Further, according to an embodiment, a separation member may be disposed between the insulating member and each of the cathode and anode terminals 21, 22 such that an end of the separation member faces a side of the electrode assembly 10.

Here, the separation member may include first and second separation members 80, 90.

Accordingly, the first and second separation members 80, 90 may be disposed between the first and second lower insulating members 60, 70 and the cathode and anode terminals 21, 22, respectively, such that an end of each of the first or second separation member 80 or 90 faces a side of the electrode assembly 10.

As a result, the cathode and anode terminals 21, 22 welded to the cathode and anode current collectors 40, 50 may be coupled to the first and second lower insulating members 60, 70 and corresponding ends of the first and second separation members 80, 90, respectively.

The lithium secondary battery 100 according to some embodiments of the present invention has been described with reference to FIG. 1 to FIG. 3. Herein, the electrode assembly of the secondary battery 100 and the anode and/or the cathode of the electrode assembly will be described.

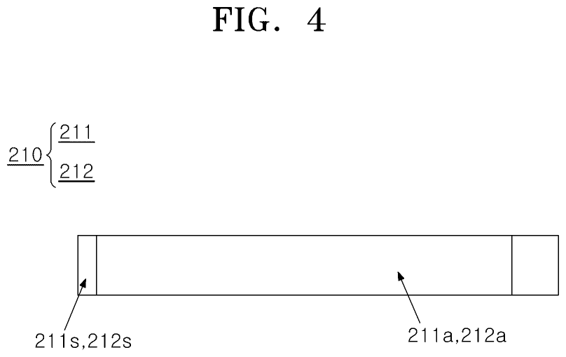

FIG. 4 is a schematic view of an electrode plate according to an embodiment of the present invention.

FIG. 4 shows an electrode plate 210 according to an embodiment of the present invention. The electrode plate 210 includes, for example, an anode 211 (for example, including the anode plate 112 in FIG. 1 or the anode 12 in FIG. 2 and FIG. 3) and a cathode 212 (for example, including the cathode plate 114 in FIG. 1 or the cathode 11 in FIG. 2 and FIG. 3).

The anode 211 includes a base 211s and an anode material layer 211a formed on the base 211s.

For example, the base 211s of the anode 211 is an anode current collector. In an embodiment, the anode current collector may be selected from among copper foil, nickel foil, stainless steel foil, titanium foil, nickel foam, copper foam, a polymer base coated with a conductive metal, and combinations thereof.

The anode material layer 211a includes an anode material and may further include a binder and/or a conductive material.

For example, the anode material layer may include 90 wt % to 99 wt % of the anode material, 0.5 wt % to 5 wt % of the binder, and optionally 5 wt % or less of the conductive material.

The anode material includes a material allowing reversible intercalation/deintercalation of lithium ions, lithium metal, lithium metal alloys, a material capable of being doped to lithium and de-doped therefrom, or a transition metal oxide.

The material allowing reversible intercalation/deintercalation of lithium ions may include a carbon-based anode material, for example, crystalline carbon, amorphous carbon, or a combination thereof. The crystalline carbon may include, for example, graphite, such as natural graphite and artificial graphite, and the amorphous carbon may include, for example, soft carbon, hard carbon, mesoporous pitch carbides, calcined coke, and the like.

The material capable of being doped to lithium and de-doped therefrom may be an Si-based anode material or an Sn-based anode material. The Si-based anode material may be silicon, a silicon-carbon composite, SiOₓ (0<x<2), Si alloys, or a combination thereof.

The silicon-carbon composite may be a composite of silicon and amorphous carbon. According to an embodiment, the silicon-carbon composite may be realized in the form of silicon particles and amorphous carbon-coated silicon particles.

The silicon-carbon composite may further include crystalline carbon. For example, the silicon-carbon composite may include a core containing crystalline carbon and silicon particles and an amorphous carbon coating layer formed on the core.

The binder may be a non-aqueous binder, an aqueous binder, a dry binder, or a combination thereof. When the aqueous binder is used as the binder, the binder may further include a cellulose compound capable of imparting viscosity.

The cathode 212 may include a base 212s and a cathode material layer 212a formed on the base 212s.

The base 212s of the cathode 212 is, for example, a current collector. In an embodiment, the current collector may be formed of Al, without being limited thereto.

The cathode material layer 212a includes a cathode material and may further include a binder and/or a conductive material.

In an embodiment, the cathode material may be present in an amount of 90 wt % to 99.5 wt % based on 100 wt % of the cathode material layer, and each of the binder and the conductive material may be present in an amount of 0.5 wt % to 5 wt % based on 100 wt % of the cathode material layer.

As the cathode material, a compound enabling reversible intercalation and deintercalation of lithium (lithiated intercalation compound) may be used. In an embodiment, the cathode material may be at least one complex oxide of a metal selected from among cobalt, manganese, nickel, and combinations thereof with lithium.

The composite oxide may be a lithium transition metal composite oxide. In an embodiment, the composite oxide may be a lithium nickel oxide, a lithium cobalt oxide, a lithium manganese oxide, a lithium iron phosphate compound, a cobalt-free nickel-manganese oxide, or a combination thereof.

By way of example, the composite oxide may be a compound represented by any of the following formulas: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0≤α≤2); LiₐNi_{1-b-c}Mn_{b}X_{c}O_{2-α}D_{α} (0.90≤a≤1.8, 0≤b≤0.5, 0≤c≤0.5, 0≤α≤2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)} Fe₂ (PO₄)₃ (0≤f≤2); and LiₐFePO₄ (0.90≤a≤1.8).

In the above formulas, A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

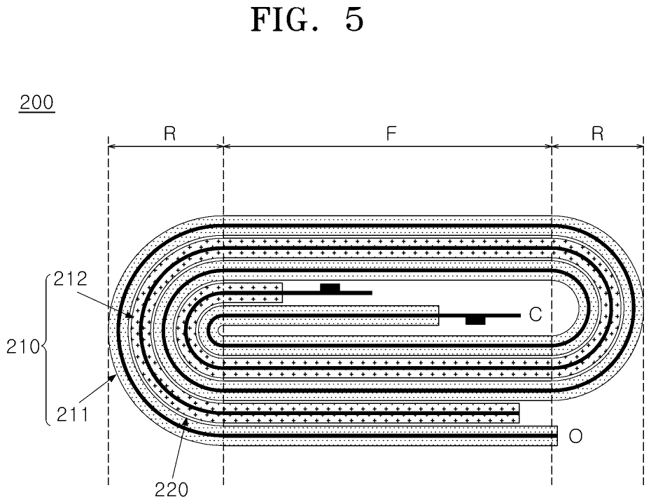

The electrode plate according to an embodiment of the present invention has been described with reference to FIG. 4. FIG. 5 shows an electrode assembly 200 including such an electrode plate 210.

FIG. 5 is a schematic view of an electrode assembly according to an embodiment of the present invention.

Referring to FIG. 5, the electrode assembly 200 according to an embodiment of the present invention (for example, including the electrode assembly 110 in FIG. 1 or the electrode assembly 10 in FIG. 2 and FIG. 3) is formed in a winding type jelly roll shape.

The electrode assembly 200 may include electrode plates 210 and a separator 220 interposed between the electrode plates 210. In addition, although not shown in FIG. 5, the electrode assembly 200 may further include an electrolyte. The electrode plates 210 may be the same or similar to those shown in FIG. 4.

Depending on the kind of secondary battery (for example, including the lithium secondary battery 100 shown in FIG. 1 to FIG. 3), the separator 220 may be interposed between the cathode 212 and the anode 211. As such a separator 220, a multilayer membrane of polyethylene, polypropylene, polyvinylidene fluoride, or two or more layers thereof may be used.

The separator 220 may include a porous base and a coating layer formed on one or both surfaces of the porous base and including an organic material, an inorganic material, or a combination thereof.

The organic material may include a polyvinylidene fluoride polymer or a (meth)acrylic polymer.

In an embodiment, the inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof, without being limited thereto.

The organic material and the inorganic material may be present in a mixed state in one coating layer or in the form of a stack structure of a coating layer containing the organic material and a coating layer containing the inorganic material.

In an embodiment, the electrolyte for the lithium secondary battery 100 includes a non-aqueous organic solvent and a lithium salt.

The non-aqueous organic solvent acts as a medium through which ions involved in electrochemical reaction of the battery can migrate.

The non-aqueous organic solvent may be a carbonate solvent, an ester solvent, an ether solvent, a ketone solvent, an alcohol solvent, a non-amphoteric solvent, or a combination thereof, and may be used alone or as a mixture thereof.

In an embodiment, a mixture of cyclic and chain carbonates may be used as the carbonate solvent.

The electrode plate 210 according to an embodiment of the present invention has been described with reference to FIG. 4 and FIG. 5. As described with reference to FIG. 4, the electrode plate 210 is rolled together with the separator 220 to form a winding type jelly roll-shaped electrode assembly 200. For example, the electrode assembly 200 has curved surfaces at both sides thereof and side surfaces each connecting the curved surfaces to each other at both sides thereof and having a flat surface. Here, referring to FIG. 5, the electrode assembly 200 includes a flat section F and a curved section R. The flat section F is a portion that remains flat as the electrode plate 210 (and/or the separator 220) is rolled into a winding type jelly roll shape. The curved section R is a portion at which a curvature is formed on the electrode plate as the electrode plate 210 (and/or the separator 220) is rolled into the winding type jelly roll shape.

The curved section R becomes a stress concentration region subjected to stress. For example, the electrode plate 210 can expand during a formation process, a coat formation process performed during degradation of the secondary battery 100, an SEI formation process, by-product reaction, and the like. Here, the curved section R can be deformed. Accordingly, it is desirable to provide measures capable of suppressing deformation of the electrode plate while improving performance of the electrode plate. Herein, these measures will be described in further detail.

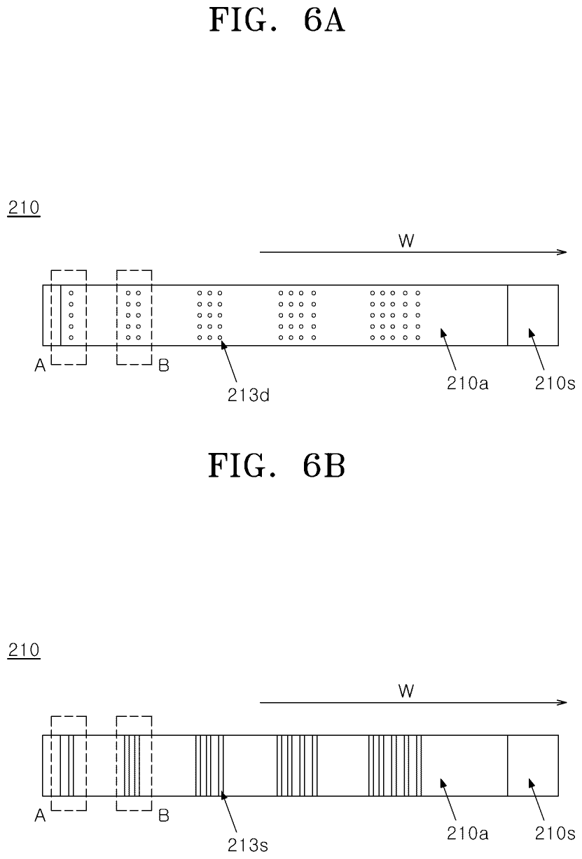

FIG. 6A and FIG. 6B are schematic views of electrode plates according to embodiments of the present invention.

Referring to FIG. 6A and FIG. 6B, reference numeral 210 denotes an electrode plate. As described with reference to FIG. 4 and FIG. 5, the electrode plate 210 includes any of the anode 211 and the cathode 212. However, in the following description with reference to FIG. 6, for convenience of description, the electrode plate 210 will be described without dividing the electrode plate into the anode 211 and the cathode 212. Accordingly, FIG. 6A and FIG. 6B and the following description are applied to the anode 211 and/or the cathode 212.

As shown in FIG. 6A and FIG. 6B, the electrode plate 210 includes a base 210s and an active material layer 210a formed on the base 210s. The base 210s and/or the active material layer 210a may be the same as or similar to those described with reference to FIG. 4 and FIG. 5.

The active material layer 210a includes a plurality of regions (for example, A, B) each including a pattern 213 on a surface thereof.

The plurality of regions is formed with the pattern 213. The plurality of regions includes, for example, a first region A and a second region B.

In FIG. 6A and FIG. 6B, W indicates a direction in which the electrode plate 210 is wound. The electrode plate 210 is wound from a first side to a second side. Here, the plurality of regions (for example, A, B) corresponds to regions on which stress is concentrated upon winding of the electrode plate 210. Accordingly, the plurality of regions (for example, A, B) may correspond to the curved section R of the electrode assembly 200 shown in FIG. 5. In an embodiment, the first side of the electrode plate 210 corresponds to a central portion of the wound electrode plate 210 when the electrode plate 210 is wound. The second side of the electrode plate 210 corresponds to an outer periphery of the wound electrode plate 210 when the electrode plate 210 is wound. The first region A is formed closer to the first side of the electrode plate 210 than the second region B. That is, the first region A is placed closer to the central portion of the wound electrode plate 210 than the second region B. That is, when the electrode plate 210 is wound into a jelly roll shape, the first region A is placed closer to a roll core of the jelly roll shape than the second region B.

In an embodiment, as shown in FIG. 6A and FIG. 6B, a number (density) of patterns 213 on the surface of the active material layer 210a increases in the winding direction W. That is, the second region B is a region having a greater number of patterns than the first region A.

In an embodiment, the pattern 213 includes any of types of patterns concavely recessed from the surface of the active material layer 210a. In another embodiment, the pattern 213 includes any of types of patterns convexly protruding from the surface of the active material layer 210a. In another embodiment, the pattern 213 includes planar patterns printed in the form of perforations on the surface of the active material layer 210a. However, by way of example, the pattern 213 formed in a concavely recessed shape will be described for convenience of description.

The pattern 213 is formed on the active material layer 210a by, for example, the following method. For example, the pattern 213 may be formed by rollers having protrusions corresponding to the pattern 213. Here, the base 210s having the active material layer 210a formed thereon may be subjected to drawing, rolling, and withdrawal between the rollers having the protrusions thereon. As a result, the pattern 213 is formed on the active material layer 210a. In another embodiment, for example, the pattern 213 is formed by a stamp in which protrusions corresponding to the pattern 213 are formed. Here, the pattern 213 is formed by applying pressure to the stamp toward the active material layer 210a. By pressing the surface of the active material to form the pattern 213 in this way, it is possible to form the pattern 213 on the electrode plate 210 without loss of the active material layer 210a or the active material. However, it is to be understood that the present invention is not limited thereto, and the pattern 213 may be formed by any suitable method that can form the pattern 213 in a concave and/or convex shape on the active material layer 210a.

Some examples of the pattern 213 will be described with reference to FIG. 6A and FIG. 6B.

FIG. 6A is a view illustrating an example in which the pattern 213 is formed in the form of dots.

Referring to FIG. 6A, the pattern 213 includes one or more dot-shaped patterns. For example, the pattern 213 includes a plurality of dots 213d arranged at intervals (e.g., certain intervals). In an embodiment, the plurality of dots 213d may be equally spaced apart from each other in a longitudinal direction and/or a transverse direction. In another embodiment, the plurality of dots 213d may be arranged at different intervals in either of the longitudinal and transverse directions while being arranged at constant intervals in either of the longitudinal and transverse directions. In another embodiment, the plurality of dots 213d may be arranged at different intervals in the longitudinal and transverse directions, for example, so as to be randomly arranged.

Although not shown in detail in FIG. 6A, the dots 213d may be formed, for example, in a conical shape, a cylindrical shape, or the like. Although dots 213d having a circular shape are shown in FIG. 6A, the dots 213d may be formed in a polygonal shape, such as a rectangular shape, a triangular shape, or the like in a plan view. Accordingly, in an embodiment, the dots 213d may be formed in a faceted cone shape, a faceted column shape, or the like.

In an embodiment, the dots 213d are formed to a depth of, for example, 2 μm to 100 μm. Further, in an embodiment, the dots 213d are formed at an interval of, for example, 10 μm to 50 μm. Further, in an embodiment, the dots 213d are formed to a diameter of, for example, 50 μm to 100 μm. Further, in an embodiment, the dots 213d are formed at a hole density of, for example, 4 pt/mm² to 625 pt/mm². However, it is to be understood that these are provided by way of example to illustrate an arrangement, shape, or size of one or more dots 213d, but the present invention is not limited thereto.

As described above, the number of dots in the second region B is greater than the number of dots in the first region A. For example, the number of dots in the second region B may be twice the number of dots in the first region A.

For example, the number of dots formed in the plurality of regions may be determined by an equation: n×m. Here, m is the number of dots formed in a region closest to a first side of the electrode plate 210 among the plurality of regions. n is an order of the plurality of regions from the first side of the electrode plate 210. For example, among the plurality of regions, the region closest to the first side of the electrode plate 210 is the first region A. The first region A is placed first from the first side of the electrode plate 210 and n is 1. In an embodiment, for example, the first region A includes five dots. The second region B is placed second from the first side of the electrode plate 210, and, for example, n is 2. As such, for example, the number of dots in the second region B may be 10, which corresponds to (2×5).

However, the number of dots is not set by the above description so long as the number of dots increases from the first region A toward the second region B. For example, the number of dots in each of the plurality of regions may be set randomly, for example, so long as the number of dots increases from the first region A toward the second region B.

FIG. 6B is a view illustrating an example in which the pattern 213 is a pattern in the form of stripes.

Referring to FIG. 6B, the pattern 213 includes a pattern in the form of one or more stripes 213s. For example, the pattern 213 includes a single stripe or a plurality of stripes 213s arranged at intervals (e.g., certain intervals). The plurality of stripes 213s may be arranged at the same or different intervals.

As shown in FIG. 6B, at least one of the one or more stripes 213s is formed from a first side to a second side of the active material layer 210a in the transverse direction thereof. In another embodiment, at least one of the one or more stripes 213s is formed from a side near the first side of the active material layer 210a to a side near the second side thereof in the transverse direction thereof, unlike the structure shown in FIG. 6B. In another embodiment, at least one of the one or more stripes 213s is formed from a side near the first side of the active material layer 210a to the second side thereof in the transverse direction thereof. That is, the one or more stripes 213s have the same length as or a smaller length than a short side of the active material layer 210a.

Although not shown in detail in FIG. 6B, the one or more stripes 213s may be formed, for example, in a quadrangular pyramid shape, a quadrangular column shape, or the like. In an embodiment, the stripes 213s are formed to a depth of, for example, 2 μm to 100 μm. Further, in an embodiment, the plurality of stripes 213s is formed at an interval of, for example, 10 μm to 50 μm. Further, in an embodiment, the stripes 213s are formed to have a width of, for example, 50 μm to 100 μm. However, it is to be understood that these are provided by way of example to illustrate an arrangement, shape, or size of the one or more stripes 213s, but the present invention is not limited thereto.

As described above, the number of stripes in the second region B is greater than the number of stripes in the first region A. In an embodiment, for example, the number of stripes in the second area B is twice the number of stripes in the first area A.

For example, the number of stripes in the plurality of regions may be determined by an equation: n×m. Here, m is the number of stripes in a region closest to a first side of the electrode plate 210 among the plurality of regions, and n is an order of the plurality of regions from the first side of the electrode plate 210. For example, among the plurality of regions, the region closest to the first side of the electrode plate 210 is the first region A. The first region A is placed first from the first side of the electrode plate 210, and, in an embodiment, n is 1, such that the first region A includes one stripe. The second region B is placed second from the first side of the electrode plate 210 and, in an embodiment, n is 2, such that the number of stripes in the second region B is 2, which corresponds to (2×1).

However, the number of stipes is not set by the above standard so long as the number of stripes increases from the first region A toward the second region B. For example, the number of stripes in each of the plurality of regions may be set randomly so long as the number of stripes increases from the first region A toward the second region B.

With the patterns 213 formed in the plurality of regions (for example, A, B) on the surface of the active material layer 210a, as shown in FIG. 6A and FIG. 6B, the electrode plate according to embodiments of the present invention can provide measures to further suppress generation of cracks and/or deformation at the stress concentration portion. Here, deformation may include, for example, a change in thickness of the electrode plate 210 or a secondary battery 210 including the electrode plate 210. Further, the electrode plate according to embodiments of the present invention has an increased surface area, thereby improving the electrolyte impregnation rate while reducing the precipitation amount of lithium ions.

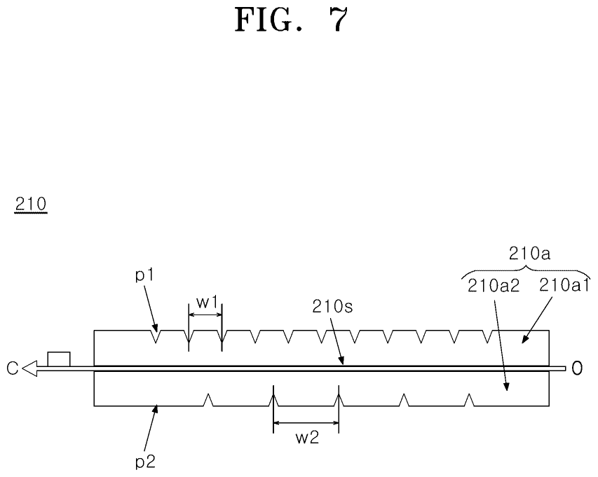

FIG. 7 is a schematic view of an electrode plate according to an embodiment of the present invention.

FIG. 5 shows the electrode plate 210 according to the embodiment of the present invention, which includes the active material layer 210a on one surface of the base 210s. FIG. 7 shows an embodiment in which the electrode plate 210 includes a base 210s and active material layers 210a formed on both surfaces of the base 210s. Further, in FIG. 7, C indicates a side close to the central portion of the jelly roll shape, and O indicates a side close to the outer periphery of the jelly roll shape, when the electrode plate 210 is rolled into the jelly roll shape.

Referring to FIG. 7, the active material layers 210a include a first active material layer 210a1 and a second active material layer 210a2. The first active material layer 210a1 is formed on a surface of the base 210s, and the second active material layer 210a2 is formed on another surface of the base 210s. Description of the active material layers 210a1, 210a2 is the same or similar to that described with reference to FIG. 1 to FIG. 6.

The first active material layer 210a1 includes a plurality of first patterns p1 on a surface thereof. The first patterns p1 correspond to the patterns 213 shown in FIGS. 6A and 6B and description of the first patterns p1 is the same as or similar to description thereof.

The second active material layer 210a2 includes one or more second patterns p2 on a surface thereof. The second patterns p2 correspond to the patterns 213 shown in FIG. 6A and FIG. 6B and description of the second patterns p2 is the same as or similar to description thereof.

Here, when the electrode plate 210 is rolled into the jelly roll shape, the first active material layer 210a1 is rolled to face an interior of the jelly roll shape. In addition, the second active material layer 210a2 is rolled to face an outside of the jelly roll shape. Accordingly, the first active material layer 210a1 may be subjected to greater stress than the second active material layer 210a2 upon rolling.

As such, the electrode plate 210 according to the present embodiment of the present invention is formed such that the number of second patterns p2 is the same as the number of first patterns p1, or the number of first patterns p1 is greater than the number of second patterns p2. In addition, for example, the electrode plate 210 is formed such that a distance w1 between the first patterns is equal to or less than a distance w2 between the second patterns.

As such, the electrode plate 210 according to the present embodiment of the present invention is formed such that the numbers of patterns p1, p2 formed on the surfaces of the active material layers 210 on both, or opposite, surfaces of the base 210a are different from each other. With this structure, the electrode plate according to the present embodiment of the present invention can have improved performance as an electrode while minimizing or reducing deformation even when the electrode plate 210 is rolled into the jelly roll shape.

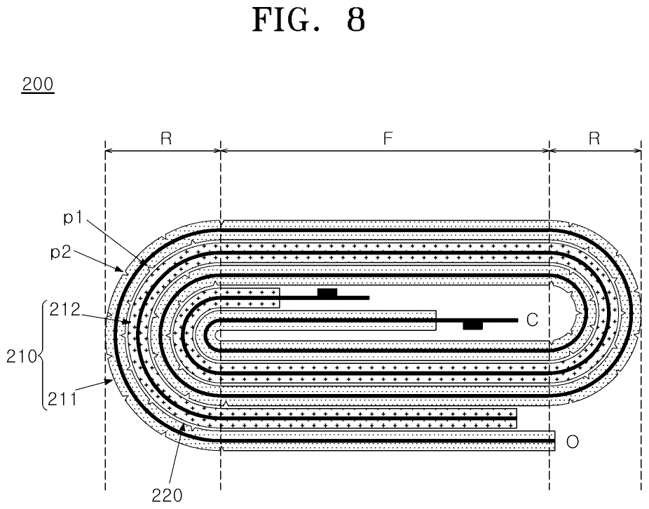

FIG. 8 is a schematic view of an electrode assembly according to an embodiment of the present invention.

In FIG. 8, reference numeral 200 denotes an electrode assembly according to an embodiment of the present invention. In FIG. 8, C indicates the central portion (for example, a first side of the electrode plate 210 shown in FIG. 6 and FIG. 7) of the electrode assembly 200, and O indicates an outer periphery (for example, a second side of the electrode plate 210 shown in FIG. 6 and FIG. 7) of the electrode assembly 200. In FIG. 8, F represents a flat section and R represents a curved section.

Referring to FIG. 8, the electrode assembly 200 includes the electrode plate 210 and the separator 220 described with reference to FIG. 6A, FIG. 6B and FIG. 7. The electrode assembly 200 includes a laminate formed by stacking the electrode plate 210 and the separator 220. For example, the laminate is formed by stacking the separator 220 between the anode 211 and the cathode 212. The electrode assembly 200 is formed by rolling the laminate into a winding type jelly roll shape.

Here, as described above, at least part of the electrode plate 210 according to an embodiment may have one or more patterns p1, p2 on the surface thereof. The patterns p1, p2 are formed on the curved section R. With this structure, the patterns p1, p2 may minimize or reduce cracking and/or deformation caused by stress applied to the curved section R.

The electrode assembly 200 is inserted and/or sealed in a case. An electrolyte is injected into the case together with the electrode assembly 200. In this way, a secondary battery according to an embodiment of the present invention is formed.

Although FIG. 8 shows a structure in which the active material layers 211a, 212a are formed on both, or opposite, surfaces 211s, 212s of the base, the active material layer may be formed on only one surface of the base, unlike the structure shown in FIG. 8.

In addition, although FIG. 8 shows the structure in which the patterns p1, p2 are formed only on the surface of the anode 211, the patterns may be formed on the surfaces of both the anode 211 and the cathode 212, or only on the surface of the cathode 212, unlike the structure shown in FIG. 8.

In this way, embodiments of the present invention provide the electrode plate and/or the electrode assembly that achieve improvement in electrolyte impregnation and ion mobility through an increase in surface area thereof. Accordingly, embodiments of the present invention can provide secondary batteries with improved high power and/or low temperature life span characteristics.

In addition, through the above measures, the electrode plate and/or the electrode assembly according to embodiments of the present invention can suppress an increase in swelling force of the electrode plate while minimizing or reducing deformation of the curved section. Accordingly, embodiments of the present invention can provide secondary batteries with long life span.

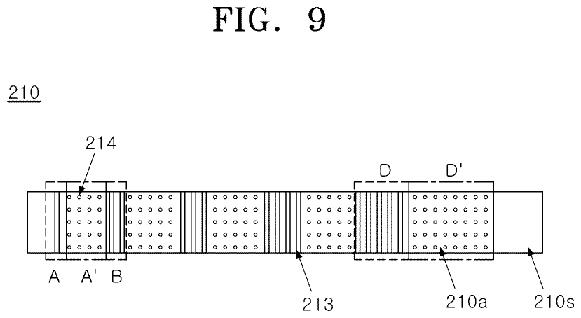

FIG. 9 is a schematic view of an electrode plate according to an embodiment of the present invention.

FIG. 9 is a view of an example of additional patterns formed on the active material layer 210a of the electrode plate 210 described with reference to FIG. 6A and FIG. 6B to FIG. 8.

As described above, the electrode plate 210 according to an embodiment of the invention includes the base 210s and the active material layer 210a formed on a surface of the base 210s. The active material layer 210a includes the pattern 213 on the surface thereof, as described with reference to FIG. 6A and FIG. 6B to FIG. 8. In addition, the active material layer 210a may further include a sub-pattern 214 on the active material layer 210a.

Referring again to FIG. 9, at least a portion of the sub-pattern 214 is disposed between the plurality of regions (for example, A, B) described with reference to FIG. 6A and FIG. 6B. Accordingly, the sub-pattern 214 may be disposed, for example, between the patterns 213. For example, the plurality of regions includes a first region A and a second region B. The sub-pattern 214 is formed in a region A′ between the first region A and the second region B. In another embodiment, the sub-pattern 214 may be formed, for example, at a side of the pattern 213. For example, the plurality of regions includes a third region D. The sub-pattern 214 is formed in a region D′ at a side of the third region D.

As shown in FIG. 6A and FIG. 6B, the pattern 213 is formed in the region corresponding to the stress concentration portions. In addition, the sub-pattern 214 is formed between the stress concentration portions. For example, the sub-pattern 214 is formed at a location corresponding to the flat section F when the electrode plate 210 is rolled into the winding type jelly roll shape.

The pattern formed closest to a first side of the electrode plate 210 (for example, the first side described with reference to FIG. 6A and FIG. 6B to FIG. 8, including the central portion of the wound electrode plate 210) is the pattern 213. In addition, the pattern closest to a second side of the electrode plate 210 (for example, the second side in FIG. 6 to FIG. 8, including the outer periphery of the wound electrode plate 210) is the pattern 213 or the sub-pattern 214. The pattern formed at the second side of the electrode plate 210 depends on whether the second side of the wound electrode plate 210 is placed on the curved section R or the flat section F.

In an embodiment, an arrangement, shape, or size of the sub-pattern 214 is the same or similar to the arrangement, shape, or size of the pattern 213.

For example, the pattern 213 may include a pattern in the form of stripes. Further, the sub-pattern 214 may include a dot-shaped pattern. For example, the pattern 213 is formed in the form of stripes and the sub-pattern 214 is formed in the form of dots. However, it is to be understood that the present invention is not limited thereto. For example, the pattern 213 and/or the sub-pattern 214 may be formed in the form of dots or stripes. That is, the pattern 213 and the sub-pattern 214 may have the same or similar shape to each other.

As described with reference to FIG. 7, the electrode plate 210 according to the embodiment of the invention described with reference to FIG. 9 may also include the active material layers 210a formed on both surfaces of the base 210s. In addition, each of the active material layers 210a formed on both surfaces of the base material 210s may be formed with patterns (for example, the patterns at one side, such as p1 and p2, are formed more densely than the patterns at the other side, in which a dense pattern side faces the interior of the jelly roll shape when the electrode plate is rolled into the winding type jelly roll shape). Here, the pattern on each of the active material layers 210a on both surfaces of the base 210s corresponds to the pattern 213 and/or the sub-pattern 214.

As shown in FIG. 9, with the pattern 213 formed in the plurality of regions (for example, A, B) on the surface of the active material layer 210a and the sub-pattern 214 formed between the plurality of regions or at a side of the plurality of regions, the electrode plates according to embodiments of the present invention can suppress generation of cracks and/or deformation at the stress concentration portions. Further, the electrode plates according to embodiments of the present invention have improved rapid charge performance. Further, the electrode plates according to embodiments of the invention have an increased surface area, thereby improving the electrolyte impregnation rate while reducing a precipitation amount of lithium ions.

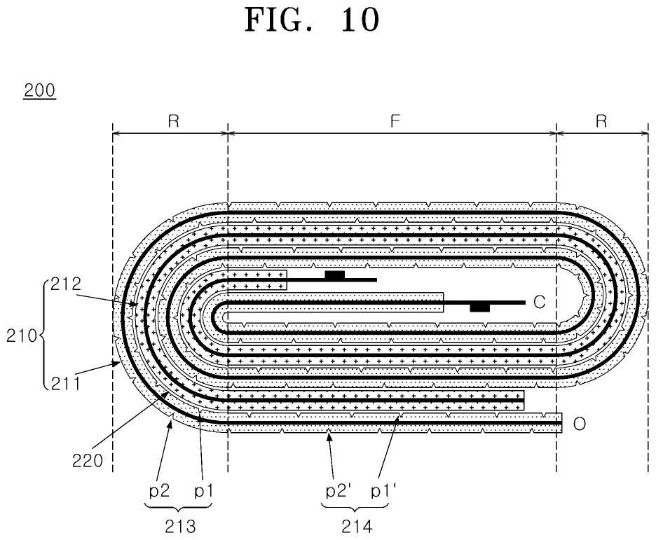

FIG. 10 is a schematic view of an electrode assembly according to an embodiment of the present invention.

In FIG. 10, reference numeral 200 denotes an electrode assembly according to an embodiment of the present invention. In FIG. 10, C indicates the central portion (for example, a first side of the electrode plate 210 shown in FIG. 9) of the electrode assembly 200, and O indicates an outer periphery (for example, a second side of the electrode plate 210 shown in FIG. 9) of the electrode assembly 200. In FIG. 10, F represents a flat section and R represents a curved section.

Referring to FIG. 10, the electrode assembly 200 includes the electrode plate 210 and the separator 220 described with reference to FIG. 9. The electrode assembly 200 includes a laminate formed by stacking the electrode plate 210 and the separator 220. For example, the laminate is formed by stacking the separator 220 between the anode 211 and the cathode 212. The electrode assembly 200 is formed by rolling the laminate into a winding type jelly roll shape.

Here, as described above, at least a portion of the electrode plate 210 according to an embodiment may have one or more patterns p1, p2 (for example, corresponding to the pattern 213) on the surface thereof. The patterns p1, p2 are formed on the curved section R. Here, the pattern p1 may be formed in a same density as the pattern p2 or may be more densely formed than the pattern p2. With this structure, the patterns p1, p2 can minimize or reduce generation of cracks and/or deformation caused by stress applied to the curved section R.

In addition, as described above, at least a portion of the electrode plate 210 according to an embodiment of the present invention may have one or more patterns p1′, p2′ (for example, corresponding to the sub-pattern 214) on the surface. The patterns p1′, p2′ are formed on the flat section F. Here, the pattern p1′ may be formed in a same density as the pattern p2′ or may be more densely formed than the pattern p2′. With this structure, the patterns p1′, p2′ increase the surface area of the active material layer 210a while improving rapid charge performance.

The electrode assembly 200 is inserted and/or sealed in a case. An electrolyte is injected into the case together with the electrode assembly 200. In this way, a secondary battery according to an embodiment of the present invention is formed. The secondary battery includes, for example, a pouch-type or prismatic secondary battery.

Although FIG. 10 shows a structure in which the active material layers 211a, 212a are formed on both surfaces 211s, 212s of the base, the active material layer may be formed on only one surface of the base, unlike the structure shown in FIG. 10.

In addition, although FIG. 10 shows a structure in which the patterns p1, p2 are formed only on the surface of the anode 211, the patterns may be formed on the surfaces of both the anode 211 and the cathode 212, or only on the surface of the cathode 212, unlike the structure shown in FIG. 10.

In this way, embodiments of the present invention provide the electrode plate and/or the electrode assembly that achieve improvement in electrolyte impregnation and ion mobility through an increase in surface area thereof. Accordingly, embodiments of the present invention can provide secondary batteries with improved high power and/or low temperature life span characteristics.

With the above structures, the electrode plate and/or the electrode assembly according to embodiments of the present invention can suppress an increase in swelling force of the electrode plate while minimizing or reducing deformation of the curved section. Accordingly, embodiments of the present invention can provide secondary batteries that secure long life span.

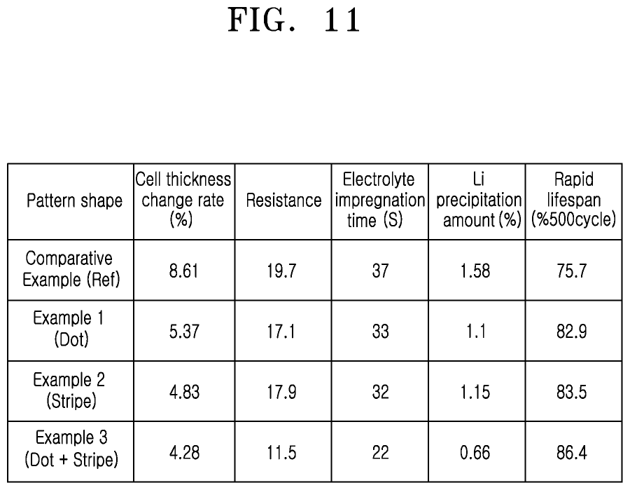

FIG. 11 is a table showing performance of the electrode plates according to embodiments of the present invention.

FIG. 11 is a tabular representation of performance difference between the electrode plates 210 according to the embodiments of the present invention shown in FIG. 6A and FIG. 6B to FIG. 10 and a conventional electrode plate.

In FIG. 11, a comparative example is an electrode plate in which no pattern is formed on the surface of the active material layer.

In FIG. 11, Example 1 is an example of the electrode plate shown in FIG. 6A, in which the dot-shaped pattern 213 is formed on the active material layer 210a. In FIG. 11, Example 2 is an example of the electrode plate shown in FIG. 6B, in which the stripe-shaped pattern 213 is formed on the active material layer 210a. In FIG. 11, Example 3 is an example of the electrode plate 210 including the pattern 213 and the sub-pattern 214, as shown in FIG. 9, in which the pattern 213 is formed in a dot shape and the sub-pattern 214 is formed in a stripe shape.

In FIG. 11, the electrode plates of Examples 1 to 3 include the engraved pattern 213 formed to a depth of 15 μm to 55 μm. Each of the electrode plates 210 of Example 1 and Example 3 includes the dot-shaped pattern formed over the electrode plate 210 except for a region in which the stripe-shaped pattern is formed. Here, a single pattern may include dot patterns formed at an interval of 100 pt/mm² to 625 pt/mm². The electrode plate 210 may have such a single pattern formed in each of a plurality of regions (for example, A, B in FIG. 6). In addition, each of the electrode plates 210 of Example 2 and Example 3 includes stripe patterns formed at intervals of 30 μm to 200 μm within such a single pattern. Further, the electrode plate 210 may include such a single pattern formed in each of the plurality of regions (for example, A, B in FIG. 9).

Here, performance of the electrode plate includes a cell thickness change rate (%), resistance (Ω/cm²), an electrolyte impregnation time(s), a lithium (Li) precipitation amount (%), and/or rapid lifespan (% @500 cycles).

As shown in FIG. 11, it can be seen that Example 1 exhibits a decrease in cell thickness change rate (%) from 8.61% to 5.37%, as compared to the comparative example. Example 2 exhibits a decrease in cell thickness change rate (%) from 8.61% to 4.83%, as compared to the comparative example. Example 3 exhibits a decrease in cell thickness change rate (%) from 8.61% to 4.28%, as compared to the comparative example. Here, the cell thickness change rate (%) indicates the degree of deformation or swelling that the electrode plate 210 or the secondary battery 100 including the electrode plate 210 undergoes. Specifically, the cell thickness change rate (%) is a measurement of change in cell thickness before and after charge lifetime (SOH90, SOH80), for example, a measurement of change in cell thickness every 100 cycles. As can be seen from FIG. 11, the examples according to the present invention have a smaller change rate in cell thickness than the comparative example.

As shown in FIG. 11, it can be seen that Example 1 exhibits a decrease in resistance from 19.7 Ω/cm² to 17.1 Ω/cm², as compared to the comparative example. Example 2 exhibits a decrease in resistance from 19.7 Ω/cm² to 17.9 Ω/cm², as compared to the comparative example. Example 3 exhibits a decrease in resistance from 19.7 Ω/cm² to 11.5 Ω/cm², as compared to the comparative example. Here, the resistance indicates resistance of a secondary battery (cell) 100 into which the electrode assembly 200 is inserted. Specifically, the resistance is ionic resistance and measured by a two-probe method using an impedance analyzer (Solartron 1260A Impedance/Gain-Phase Analyzer) at 25° C. From FIG. 11, it can be seen that the examples according to the present invention contribute to a high-performance cell with lower resistance and higher output than the comparative example.

As shown in FIG. 11, it can be seen that Example 1 exhibits a reduction in electrolyte impregnation time(s) from 37 seconds to 33 seconds, as compared to the comparative example. Example 2 exhibits a reduction in electrolyte impregnation time(s) from 37 seconds to 32 seconds, as compared to the comparative example. Example 3 exhibits a reduction in electrolyte impregnation time(s) from 37 seconds to 22 seconds, as compared to the comparative example. Here, the electrolyte impregnation time(s) is indicative of the electrolyte impregnation rate. Specifically, the electrolyte impregnation time(s) is measured by dropping the electrolyte onto the electrode plate. As can be seen from FIG. 11, the examples according to the present invention have better impregnation characteristics than the comparative example.

As shown in FIG. 11, it can be seen that Example 1 exhibits a decrease in precipitation amount (%) of lithium ions (Li) from 1.58% to 1.1%, as compared to the comparative example. Example 2 exhibits a decrease in precipitation amount (%) of lithium ions (Li) from 1.58% to 1.15%, as compared to the comparative example. Example 3 exhibits a decrease in precipitation amount (%) of lithium ions (Li) from 1.58% to 0.66%, as compared to the comparative example. Here, the precipitation amount of lithium ions indicates the extent of precipitation of lithium ions on the surface of the electrode (for example, on the surface of the anode 211) due to repeated rapid charge and discharge. Specifically, the precipitation amount (%) of lithium ions is indicative of the amount of reversible Li precipitated on the surface of the anode during rapid charge, which is quantified by low rate discharging after rapid charge without CV and rest intervals to determine an inflection point. As can be seen in FIG. 11, the examples according to the present invention undergo less precipitation of lithium ions than the comparative example.

Further, as shown in FIG. 11, it can be seen that Example 1 exhibits improvement in rapid lifespan (% @500 cycles) from 75.7% to 82.9% per 500 cycles, as compared to the comparative example. Example 2 exhibits improvement in rapid lifespan from 75.7% to 83.5% per 500 cycles, as compared to the comparative example. Example 3 exhibits improvement in rapid lifespan from 75.7% to 86.4% per 500 cycles, as compared to the comparative example. Here, the rapid lifespan of the electrode plate is evaluated by, for example, 2N1F, according to specification, such as No. 2 normal charge condition (0.5 C charging)+No. 1 rapid charge condition (charge by changing the C-rate according to the charge time, such as 10 minutes, 13 minutes, 15 minutes, and the like). That is, it can be seen that the examples according to the present invention have better rapid lifespan than the comparative example.

Further, as shown in FIG. 11, it can be seen that the secondary battery has better performance when the electrode plate 210 includes both the pattern 213 and the sub-pattern 214 than when the electrode plate includes only the pattern 213. As such, the electrode plate according to embodiments of the present invention can provide measures and various structures that satisfy target performance of the secondary battery including the electrode plate.

Next, examples of a secondary battery 100 and a battery module to which the electrode plate 210 and/or the electrode assembly 200 according to embodiments of the invention are applied will be described. In addition, an apparatus (for example, a vehicle) adopting a battery pack that includes the secondary battery and/or the battery module will be described below.

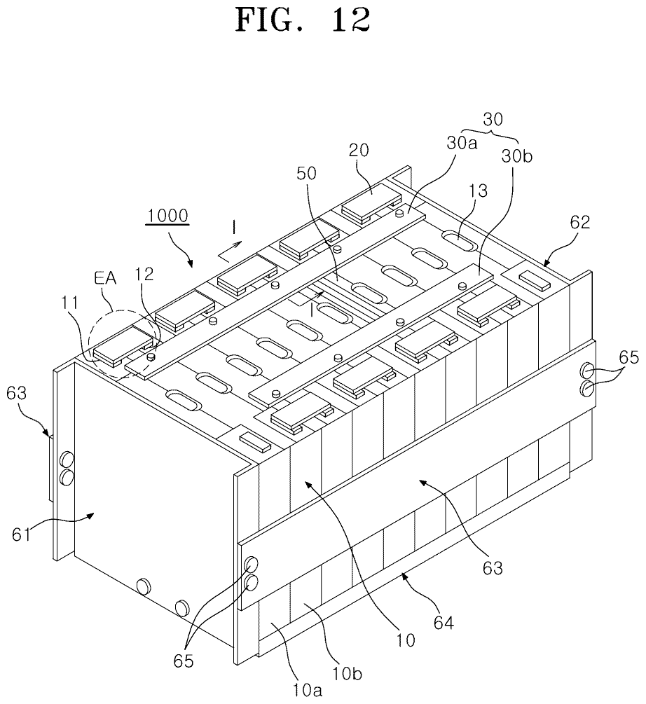

FIG. 12 is a perspective view of a battery module according to an embodiment of the present invention.

In FIG. 12, reference numeral 1000 denotes a battery module. The battery module 1000 includes a plurality of battery cells 10. The battery cells 10 may be, for example, lithium secondary batteries or secondary batteries, as described with reference to FIG. 1 to FIG. 11. Each of the battery cells 10 include, for example, one of the electrode assemblies 200 according to an embodiment of the present invention described with reference to FIG. 4 to FIG. 11, and a case that receives the electrode assembly 200 therein.

In an embodiment, referring to FIG. 12, the battery module 1000 includes a plurality of battery cells 10 each including electrodes 11, 12 and arranged in a direction, connection tabs 20 each connecting two adjacent battery cells 10a, 10b to each other, and a protection circuit module 30 connected at a side thereof to the connection tabs 20. The protection circuit module 30 may be a battery management system (BMS). In an embodiment, each of the connection tabs 20 includes a body that contacts the electrodes 11, 12 of the adjacent battery cells 10a, 10b and an extension extending from the body to be connected to the protection circuit module 30. In an embodiment, the connection tab 20 may be a busbar.

The battery cell 10 may include a battery case, and an electrode assembly and an electrolyte received in the battery case. The electrode assembly electrochemically reacts with the electrolyte to generate energy. The battery cell 10 may be provided at a side thereof with terminals 11, 12 electrically connected to the connection tab 20, and may be formed with a vent 13, which is a discharge channel of a gas generated therein. The terminals 11, 12 of the battery cell 10 may be a cathode terminal 11 and an anode terminal 12, respectively, and the terminals 11, 12 of the adjacent battery cells 10a, 10b may be electrically connected in series or in parallel by the connection tabs 20 described below. Although series connection is described above by way of example, it is to be understood that various connection structures may be used, as desired. In addition, it is to be understood that a number and arrangement of battery cells are not limited to the structure of FIG. 12 and may be changed, as desired.

The plurality of battery cells 10 may be arranged in a direction such that wide surfaces of the battery cells 10 face each other, and may be secured by a housing 61, 62, 63, 64. The housing 61, 62, 63, 64 may include a pair of end plates 61, 62 facing the wide surfaces of the battery cells 10, and side plates 63 and a bottom plate 64 each connecting the pair of end plates 61, 62 to each other. The side plates 63 may support side surfaces of each of the battery cells 10, and the bottom plate 64 may support a bottom surface of the each of battery cells 10. In addition, the pair of end plates 61, 62, the side plates 63 and the bottom plate 64 may be connected to one another by connection members, such as bolts 65 or the like.

The protection circuit module 30 may have electronic components and protection circuits mounted thereon and may be electrically connected to the connection tabs 20 described below. In an embodiment, the protection circuit module 30 may include a first protection circuit module 30a and a second protection circuit module 30b extending from different locations in an arrangement direction of the plurality of battery cells 10, wherein the first protection circuit module 30a and the second protection circuit module 30b may be spaced apart parallel to each other by a distance (e.g., a constant distance) and each may be electrically connected to the connection tabs 20 adjacent thereto. For example, the first protection circuit module 30a extends from a side of upper portions of the plurality of battery cells 10 in the arrangement direction of the plurality of battery cells 10, and the second protection circuit module 30b extends from another side of the upper portion of the plurality of battery cells 10 in the arrangement direction of the plurality of battery cells 10 such that the second protection circuit module 30b is spaced apart from the first protection circuit module 30a, with the vents 13 disposed therebetween, while being parallel to the first protection circuit module 30a. As such, the two protection circuit modules are spaced apart from each other while extending in the direction in which the plurality of battery cells is arranged, thereby minimizing or reducing an area of the printed circuit board (PCB) constituting the protection circuit module. A PCM area may be minimized or reduced by dividing the protection circuit module into two separate protection circuit modules. In addition, the first protection circuit module 30a and the second protection circuit module 30b may be connected to each other by a conductive connection member 50. Here, the connection member 50 is connected at a side thereof to the first protection circuit module 30a and at another side thereof to the second protection circuit module 30b, whereby electrical connection can be made between the two protection circuit modules 30a and 30b.

In an embodiment, the connection may be realized by any of soldering, resistance welding, laser welding, or projection welding.

The connection member 50 may be, for example, an electrical wire. In addition, the connecting member 50 may be an elastic or flexible material. By such a connection member 50, the voltage, temperature, and current of the plurality of battery cells 10 can be checked and managed to be normal. That is, information, such as voltage, current, and temperature received by the first protection circuit module from the connection tabs adjacent thereto and information, such as voltage, current, and temperature, received by the second protection circuit module from the connection tabs adjacent thereto may be integrated and managed by the protection circuit module through the connection member.

In addition, upon swelling of the battery cells 10, impact can be absorbed by elasticity or flexibility of the connection member 50 to prevent or substantially prevent damage to the first and second protection circuit modules 30a, 30b.

However, the shape and structure of the connecting member 50 are not limited to those shown in FIG. 12.

In this way, the structure of the protection circuit module 30 divided into the first and second protection circuit modules 30a, 30b can secure an interior space of the battery module by minimizing or reducing an area of the PCB that constitutes the protection circuit module. This structure improves work efficiency by facilitating not only an operation of connecting the connection tabs 20 to the protection circuit module 30, but also repair upon detection of failure of the battery module.

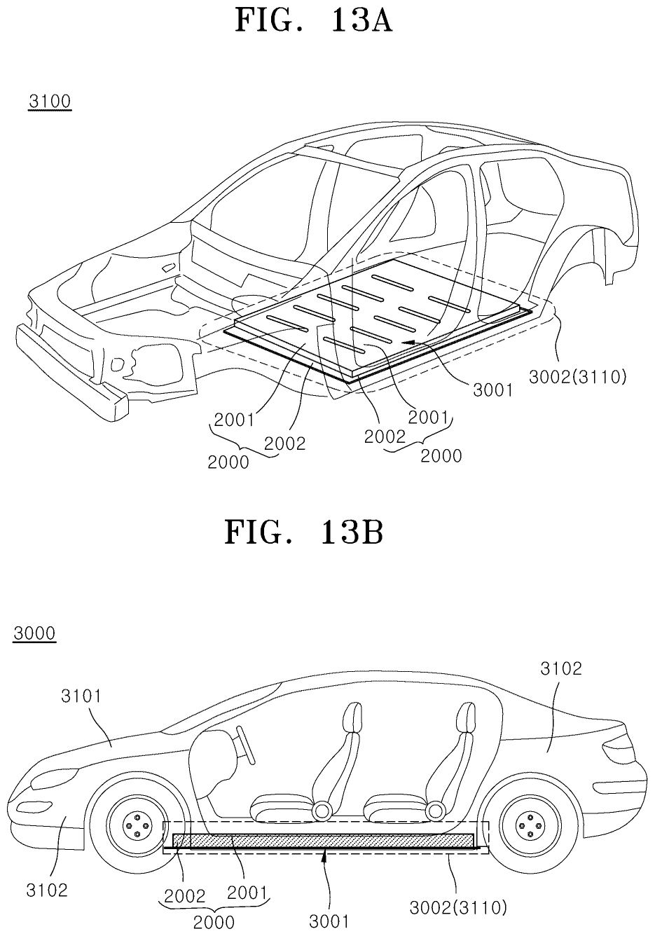

FIG. 13A and FIG. 13B are views of a vehicle body and body parts according to embodiments of the present invention.

FIG. 13A and FIG. 13B show a vehicle body and body parts including a battery pack (for example, the battery cells 10 of FIG. 12 embedded and/or sealed therein) according to an embodiment of the present invention. In the drawings, components for electrical connection of the batteries, such as busbars, cooling units, external terminals, and the like, are omitted for convenience of illustration.

In FIG. 13A, a battery pack 2000 may include a battery pack cover 2001 as a part of a vehicle underbody 3001 and a pack frame 2002 disposed under the vehicle underbody 3001. In an embodiment, the pack frame 2002 and the battery pack cover 2001 may be integrally formed with the vehicle underbody 3001.

The vehicle underbody 3001 divides an interior and an exterior of the vehicle, and the pack frame 2002 may be disposed outside the vehicle.

FIG. 13B is a schematic side view of a vehicle according to an embodiment of the present invention.

The vehicle 3000 may include a body 3100 coupled to additional components, such as a hood 3101 at a front side thereof and fenders 3102 at the front and rear sides thereof, respectively.

The vehicle 3000 may further include a vehicle floor 3002, which is one of body parts 3110 including the battery pack 2000 that includes the pack frame 2002, and the battery pack cover 2001.

An automobile according to an embodiment of the present invention includes the battery pack according to an embodiment of the present invention. The automobile may be, for example, an electric automobile, a hybrid automobile, or a plug-in hybrid automobile. The automobile may include a four-wheeled automobile or a two-wheeled automobile. The automobile operates by receiving power from the battery pack according to an embodiment of the present invention.

Although the present invention has been described with reference to some embodiments and drawings illustrating aspects thereof, the present invention is not limited thereto. Various modifications and variations can be made by a person skilled in the art to which the present invention belongs within the scope of the technical spirit of the invention and the claims and equivalents thereto.

What is claimed is:

1. An electrode plate comprising:
a base; and
an active material layer on the base and comprising a plurality of regions each having a pattern on a surface thereof,
wherein the plurality of regions comprises a first region and a second region having a greater number of patterns than the first region.

2. The electrode plate as claimed in claim 1, wherein the pattern comprises one or more stripe-shaped patterns spaced apart from each other.

3. The electrode plate as claimed in claim 1, wherein the pattern comprises one or more dot-shaped patterns.

4. The electrode plate as claimed in claim 1, wherein the active material layer further comprises one or more sub-patterns on the surface of the active material layer, and at least some of the sub-patterns are located between the plurality of regions.

5. The electrode plate as claimed in claim 1, wherein, when the electrode plate is wound, the first region is closer to a core portion of the wound electrode plate than the second region.

6. The electrode plate as claimed in claim 1, wherein at least some of the plurality of regions are located at a stress concentration portion of the electrode plate.

7. The electrode plate as claimed in claim 1, wherein the active material layer comprises a first active material layer on a surface of the base and a second active material layer formed on another surface of the base, and the pattern comprises a plurality of first patterns on the first active material layer and one or more second patterns on the second active material layer.

8. The electrode plate as claimed in claim 7, wherein a number of the first patterns is greater than a number of the one or more second patterns.

9. The electrode plate as claimed in claim 8, wherein a distance between the first patterns is less than a distance between the one or more second patterns.

10. An electrode assembly comprising:
a laminate comprising a cathode, an anode, and a separator between the cathode and the anode,
wherein at least one of the cathode and the anode comprises a base; and an active material layer on the base and comprising a plurality of regions each having a pattern thereon, the plurality of regions comprising a first region and a second region having a greater number of patterns than the first region.

11. The electrode assembly as claimed in claim 10, wherein the pattern comprises one or more stripe-shaped patterns spaced apart from each other.

12. The electrode assembly as claimed in claim 10, wherein the pattern comprises one or more dot-shaped patterns.

13. The electrode assembly as claimed in claim 10, wherein the active material layer further comprises one or more sub-patterns on the surface thereof, and at least some of the sub-patterns are located between the plurality of regions.

14. The electrode assembly as claimed in claim 10, wherein the laminate is rolled into a winding type jelly roll, and the first region is closer to a core portion of the jelly roll than the second region.

15. The electrode assembly as claimed in claim 10, wherein the laminate is rolled into a winding type jelly roll, and at least some of the plurality of regions are located in a stress concentration portion of the jelly roll.

16. The electrode assembly as claimed in claim 10, wherein the active material layer comprises a first active material layer on a surface of the base and a second active material layer on another surface of the base, and the pattern comprises a plurality of first patterns on the first active material layer and one or more second patterns on the second active material layer.

17. The electrode assembly as claimed in claim 16, wherein a number of the first patterns is greater than a number of the one or more second patterns.

18. The electrode assembly as claimed in claim 17, wherein a distance between the first patterns is less than a distance between the one or more second patterns.

19. A secondary battery comprising the electrode assembly as claimed in claim 10; and a case receiving the electrode assembly therein.

20. The secondary battery according to claim 19, wherein the secondary battery is one of a pouch-type battery or a prismatic battery.
